(19) United States
(12) Patent Application Publication
(10) Pub. No.: US 2007/0102233 A1
(43) Pub. Date: May 10, 2007

(54) Air pumping device with silencing effect for aquarium

(75) Inventor: Yu-Chin Wang, Taipei (TW)

Correspondence Address: BRUCE H. TROXELL;SUITE 1404, 5205 LEESBERG PIKE, FALLS CHURCH, VA, 22041, US

(73) Assignee: Eiko Electric Products Corp.

(21) Appl. No.: 11/267,417

(22) Filed: Nov. 7, 2005

(51) Int. Cl. G10K 11/04; H02K 5/24

(52) U.S. Cl. 181/202; 181/200

(57) ABSTRACT

An air pumping device used in an aquarium with a silencing effect, the device mainly has a housing, the housing is used to receive therein an air pump and a coil unit able to generate an alternating magnetic field; and the housing is formed therein a sealed silencing chamber covered with a covering plate. The silencing chamber has therein partitions to divide it into a front silencing chamber and a rear silencing chamber. When the air pump is operated, air is led firstly into the front silencing chamber, the air flows through the air pump and then is led into the rear silencing chamber; after an action of buffering, the air exhausts from the housing through an end of the silencing chamber.

### BACKGROUND OF THE INVENTION

1. Field of the Invention

The present invention is related to an air pumping device used in an aquarium, and especially to a pumping device with a silencing effect.

2. Description of the Prior Art

A pumping device used in an aquarium mainly pumps air into water by means of an air pump to supply sufficient air for the living things bred in the aquarium. A pumping device used presently mainly has an pumping device connected exteriorly thereof with a waving arm having on its tailing end a magnet; an electrically connected coil is used to generate an alternating magnetic field to attract and repulse the magnet for making the waving arm move to and fro, thereby a diaphragm is moved to render the air pump to continuously reject air.

By the fact that an air pump generates unpleasant and sustaining noise during operation, some air pumps are installed with silencing equipment at air exhaust ports, silencing units are provided on the main bodies of the air pumps; thereby air pumped out by the air pumps exhausts after passing through the silencing units, and an effect of silencing can be achieved.

These conventional air pumps have the problem that the main bodies of the air pumps are small and the silencing units added are not large enough, hence the effect of silencing is limited. Particularly, only the air ejected from the air pumps are silenced; the noise getting in the air pumps are unable to be eliminated.

And some air pumps are installed with silencing equipment also at air inlets, by virtue that the areas of the air inlets are so small that only a small silencing unit can be mounted for each of them, the effect of silencing is limited too, and there is further a problem of difficulty in mounting.

### SUMMARY OF THE INVENTION

In view of the above stated limitations of the conventional techniques, the inventor of the present invention breaks through the conventional thought to provide a brand new air pumping device in which a silencing unit is not attached to the main body of the air pump, rather, the silencing unit is installed in a housing of the air pumping device; in this way, the space for the silencing unit is largely increased, and the silencing unit can be designed to have a front silencing chamber and a rear silencing chamber, and a complete silencing effect can be obtained.

Accordingly, the air pumping device used in an aquarium with the silencing effect provided by the present invention mainly has a housing, the housing is used to receive therein an air pump and a coil unit able to generate an alternating magnetic field; and the housing is formed therein a sealed silencing chamber covered with a covering plate. The silencing chamber has therein partitions to divide it into a front silencing chamber and a rear silencing chamber. When the air pump is operated, air is led firstly into the front silencing chamber, the air flows through the air pump and then is led into the rear silencing chamber; after an action of buffering, the air exhausts from the housing through an end of the silencing chamber.

Because the silencing unit is designed to be installed in the housing of the air pumping device, the space for the silencing unit is largely increased, and the silencing unit can be designed to have a front silencing chamber and a rear silencing chamber, air at an inlet as well as at an air exhaust port can both be silenced, and a complete silencing effect can be obtained, the aquarium has no more disturbing noise.

The present invention will be apparent in its structural features and effect of using after reading the detailed description of the preferred embodiments thereof in reference to the accompanying drawings.

### BRIEF DESCRIPTION OF THE DRAWINGS

FIG. 1 is a side sectional view showing an embodiment of the present invention having a single air pump;

FIG. 2 is a top view showing the embodiment of FIG. 1;

FIG. 3 is an anatomic perspective view of the embodiment of FIG. 1 showing a silencing chamber;

FIG. 4 is a side sectional view showing an embodiment of the present invention having two air pumps;

FIG. 5 is a top view showing the embodiment of FIG. 4;

FIG. 6 is an anatomic perspective view of a base of the embodiment of FIG. 4;

FIG. 7 is an anatomic perspective view showing a top cover, the base and a covering plate in FIG. 4 and showing a silencing chamber.

### DETAILED DESCRIPTION OF THE PREFERRED EMBODIMENT

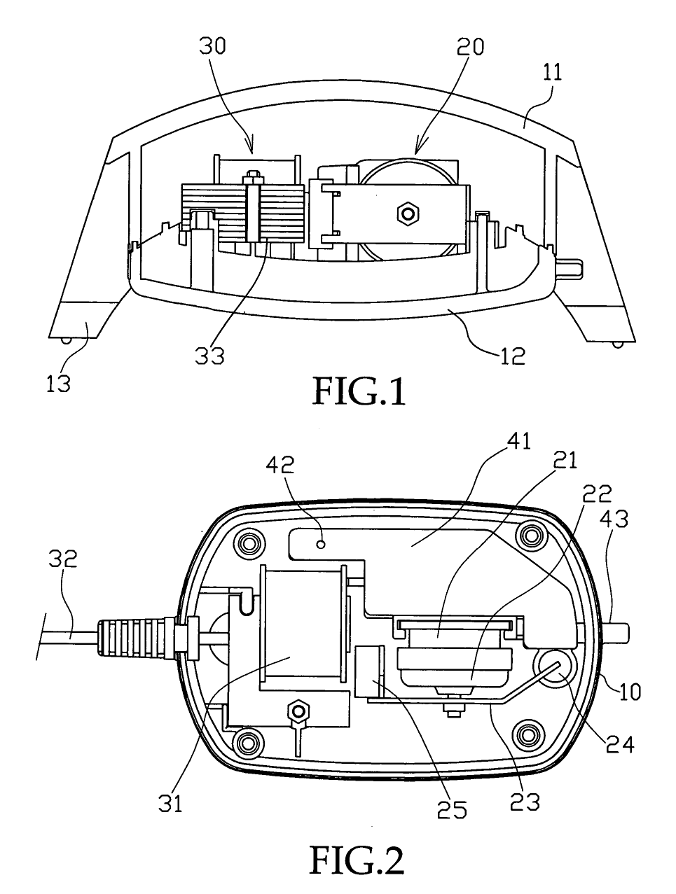

Referring to FIGS. 1 and 2, they show an embodiment of the air pumping device of the present invention having a single air pump.

The present invention has a housing 10 composed of a top cover 11 and a base 12, the top cover 11 has four corners extending downwards over the bottom surface of the base 12 to form feet having on their ends rubber pads 13. The base 12 is used to receive therein the air pump 20 and a coil unit 30 able to generate an alternating magnetic field.

The air pump 20 has a cylinder 21, the cylinder 21 is provided with a diaphragm 22 being slipped over a front end of the cylinder 21; the diaphragm 22 is connected with a waving arm 23. The waving arm 23 has a hinge 24 on one end thereof, and has a magnet 25 on its other end.

The coil unit 30 mainly has a coil 31, it is supplied with electric power from a power line 32 via a transformer 33, so that the coil 31 can generate an alternating magnetic field to attract and repulse the magnet 25 for making the waving arm 23 move to and fro, thereby a diaphragm 22 is moved to render the air pump 20 to continuously reject air. Because this is same as the conventional techniques, no further description for it is necessary.

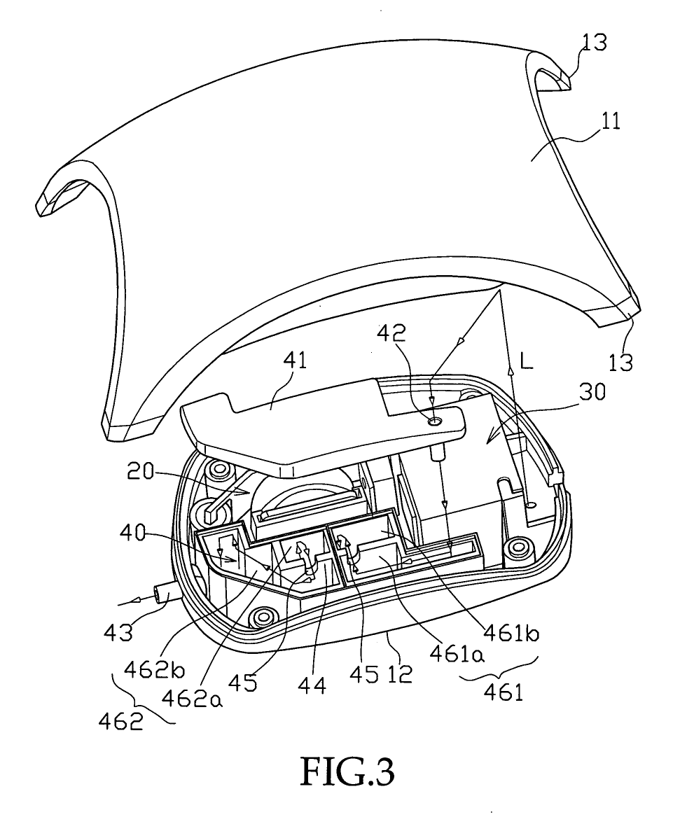

Referring to FIG. 3, the primary feature of the present invention is that the housing 10 is formed therein a silencing chamber 40 covered with a covering plate 41. The silencing chamber 40 has an air inlet 42 which is provided on the covering plate 41 in this embodiment, in order that air can enter the silencing chamber 40 from the air inlet 42. The end of the silencing chamber 40 is provided with an air exhausting pipe 43, in order that air led in from the air inlet 42 can exhaust out of the housing at last.

The silencing chamber 40 is composed of a front silencing chamber 461 and a rear silencing chamber 462 to be divided into a plurality of air chambers 461a, 461b, 462a and 462b with partitions, the air chambers 461a and 461b are communicated with each other and also the air chambers 462a and 462b are communicated with each other by means of openings 45 provided on the partitions 44.

The front silencing chamber 461 is communicated with the air inlet 42, so that air can be led in here at the communicating area. An air outlet on the end of the front silencing chamber 461 is connected with an air inlet of the air pump 20.

The rear silencing chamber 462 has an air inlet connected with an exhausting hole of the air inlet 42, and has an end connected with the air exhausting pipe 43, so that air can be exhausted from the housing 10.

Some of the air chambers formed by dividing the front silencing chamber 461 and the rear silencing chamber 462 with the partitions 44 are tortuous air chambers; they give a buffering action for the air flowing through to get an effect of eliminating noise.

FIG. 3 is depicted with flowing paths L representing the directions of air flow, when in operation of the air pump 20, air is absorbed firstly into the front silencing chamber 461 from the air inlet 42, and then enters the air pump 20; after the high speed air exhausting from the air pump 20 is led into the rear silencing chamber 462 to be silenced through the buffering action, the air exhausts from the housing 10 via the air exhausting pipe 43.

Because that the present invention is designed to have the silencing chamber 40 provided in the housing 10, it can largely increase the space of the silencing unit to get the front silencing chamber 461 and the rear silencing chamber 462, so that the air entering or exhausting from the air pump 20 can all be silenced; hence a complete silencing effect can be surely obtained, and the aquarium has no more sustaining disturbing noise.

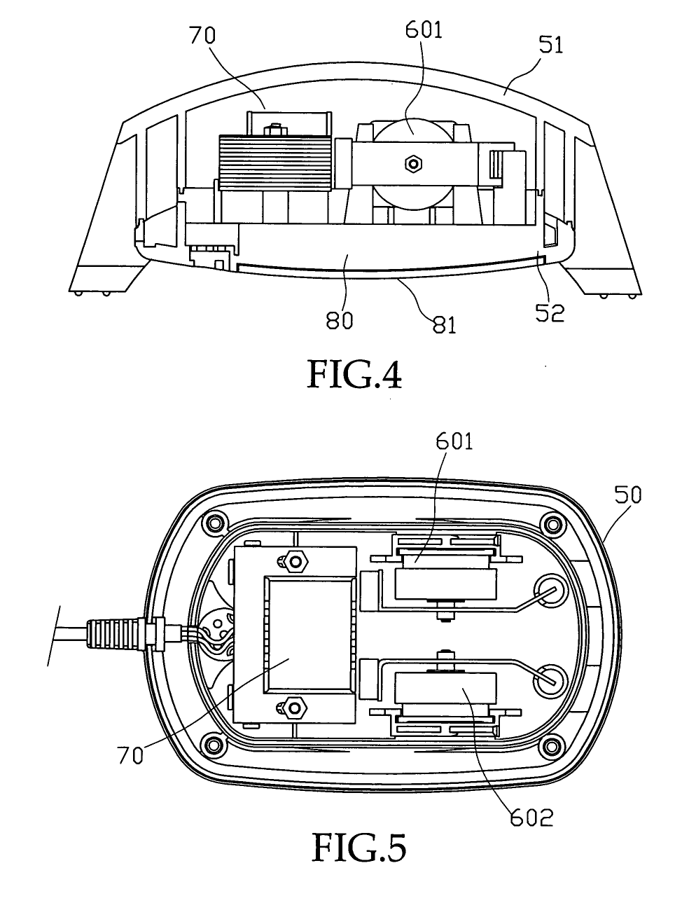

And more, referring to FIGS. 4, 5 showing an embodiment of the present invention having two air pumps, a housing 50 is provided therein with two air pumps 601 and 602, by virtue of this, plus by providing of a coil unit 70, the space above a base 52 is limited, a silencing chamber 80 is provided on the bottom of the base 52 and is covered with a covering plate 81 to seal the silencing chamber 80.

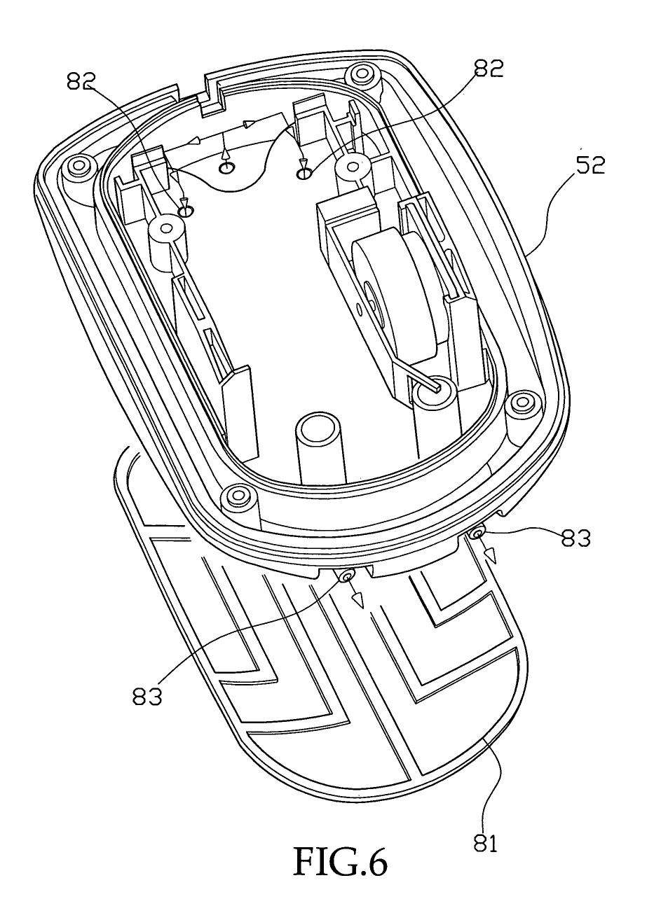

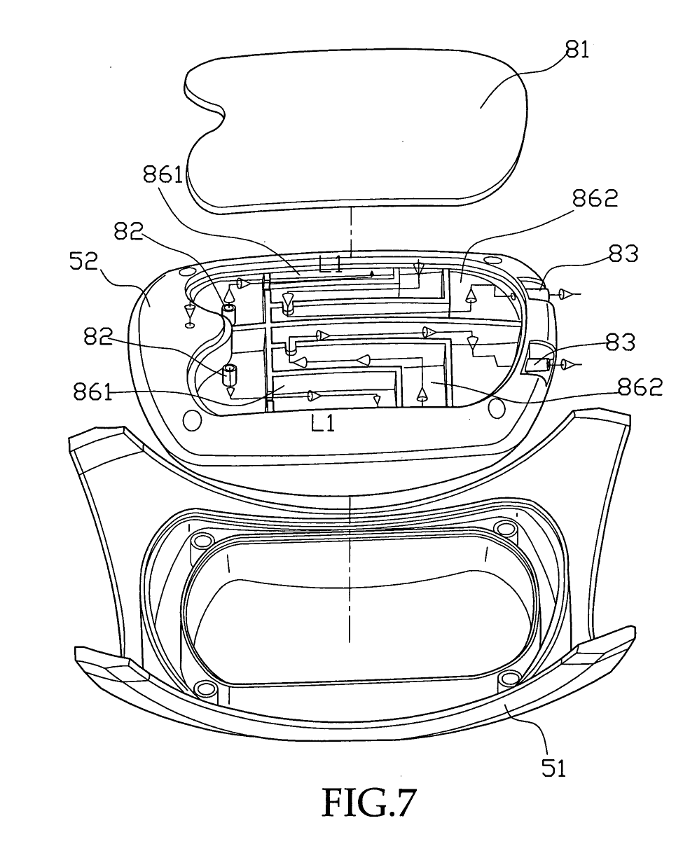

Referring to FIGS. 6, 7, in view that this embodiment of the present invention has two air pumps 601 and 602, the silencing chamber 80 must have two air inlets 82 and two air exhausting pipes 83 as are shown in FIG. 6.

FIG. 7 shows a top cover 51, a base 52 and a covering plate 81 and showing the structure of the silencing chamber 80. The silencing chamber 80 is formed to have two front silencing chambers 861 and two rear silencing chambers 862.

The front silencing chambers 861 are communicated with the air inlets 82 to allow air to be led in; air outlets on the ends of the rear silencing chambers 862 are connected respectively to the air inlets of the two air pumps 601 and 602.

The air inlets of the two rear silencing chambers 862 are connected respectively to exhausting holes of the two air pumps 601 and 602, the ends of the rear silencing chambers 862 are connected respectively to exhausting pipes 83 in order that air is exhausted from the housing 50.

A plurality of air chambers formed by dividing the two front silencing chambers 861 and the two rear silencing chambers 862 with partitions provide buffering action for the high speed air flowing through to get an effect of eliminating noise.

FIGS. 6, 7 are depicted with flowing paths L representing the directions of air flow, when in operation of the air pumps 601, 602, air is absorbed firstly into the front silencing chambers 861 from the air inlets 82, and then enters the air pumps 601, 602; after the high speed air exhausting from the exhausting holes of the air pumps 601, 602 is led into the rear silencing chambers 862 to be silenced through the buffering action, the air is exhausted from the housing 50 via the air exhausting pipes 83.

Obviously, the present invention is not limited to what is depicted in the drawings; it will be apparent to those skilled in this art that various modifications or changes can be made to the elements of the present invention without departing from the spirit and scope of this invention, such as increasing the amount of air pumps or air chambers of the silencing chamber, all such modifications and changes also fall within the scope of the appended claims.

1. An air pumping device with a silencing effect for an aquarium comprising:
a housing;
an air pump received in said housing, said air pump has a cylinder provided with a diaphragm being slipped over a front end of said cylinder; said diaphragm is connected with a waving arm, said waving arm has a hinge on its one end, and has a magnet on its other end;
a coil unit received in said housing, said coil unit generates an alternating magnetic field to operate said air pump to attract and repulse said magnet for making said waving arm move to in turn move a diaphragm to render an air exhaust port of said air pump to reject air; and
a silencing chamber covered with a covering plate and formed in said housing, said silencing chamber has an air inlet on its front end and an exhausting pipe on its rear end, and is formed therein a front silencing chamber and a rear silencing chamber;
when in operation of said air pump, air is led into said front silencing chamber via said air inlet of said silencing chamber, and is led into said rear silencing chamber to exhaust from said housing via said air exhausting pipe lastly.

2. The air pumping device with a silencing effect for an aquarium as claimed in claim 1, wherein
said front silencing chamber and rear silencing chamber are divided into a plurality of air chambers with partitions, said air chambers are communicated with each other by means of openings provided on said partitions.

3. The air pumping device with a silencing effect for an aquarium as claimed in claim 1, wherein
said housing is composed of a top cover and a base, said silencing chamber is formed on said base.

4. The air pumping device with a silencing effect for an aquarium as claimed in claim 3, wherein
said top cover has four corners extending downwards over a bottom surface of said base to form feet having on their ends rubber pads.

5. The air pumping device with a silencing effect for an aquarium as claimed in claim 1, wherein
said air inlet of said silencing chamber is provided on said covering plate.

6. An air pumping device with a silencing effect for an aquarium comprising:
a housing,
two air pumps received in said housing, each of said air pumps has a cylinder provided with a diaphragm being slipped over a front end of said cylinder; each of said diaphragms is connected with a waving arm, said waving arm has a hinge on its one end, and has a magnet on its other end;
a coil unit received in said housing, said coil unit generates an alternating magnetic field to operate said air pumps to attract and repulse said magnets for making said waving arms move to in turn move said diaphragms to render air exhaust ports of said air pumps to reject air; and
a silencing chamber covered with a covering plate and formed in said housing, said silencing chamber has two air inlets on its front end and two exhausting pipes on its rear end, and is formed therein two front silencing chambers and two rear silencing chambers;
when in operation of said air pumps, air is led into said front silencing chambers via said air inlets of said silencing chamber, and is led into said rear silencing chamber to exhaust from said housing via said air exhausting pipes lastly.

7. The air pumping device with a silencing effect for an aquarium as claimed in claim 6, wherein
said front silencing chambers and rear silencing chambers are divided into a plurality of air chambers with partitions, said air chambers are communicated with each other by means of openings provided on said partitions.

8. The air pumping device with a silencing effect for an aquarium as claimed in claim 6, wherein
said housing is composed of a top cover and a base, said silencing chamber is formed on said base.

9. The air pumping device with a silencing effect for an aquarium as claimed in claim 8, wherein
said top cover has four corners extending downwards over a bottom surface of said base to form feet having on their ends rubber pads.
